(19) United States
(12) Patent Application Publication
(10) Pub. No.: US 2024/0289522 A1
(43) Pub. Date: Aug. 29, 2024

(54) SYSTEM FOR TRACKING INCREMENTAL DAMAGE ACCUMULATION

(71) Applicant: ENDURICA, LLC, Findlay, OH (US)

(72) Inventor: William V. Mars, Findlay, OH (US)

(21) Appl. No.: 18/594,882

(22) Filed: Mar. 4, 2024

Related U.S. Application Data
(63) Continuation of application No. 16/149,738, filed on Oct. 2, 2018, now abandoned.
(60) Provisional application No. 62/567,354, filed on Oct. 3, 2017.

(51) Int. Cl. G06F 30/23; G06F 30/15; G06F 30/20; G06F 111/10; G06F 119/04

(52) U.S. Cl. CPC G06F 30/23; G06F 30/15; G06F 30/20; G06F 2111/10; G06F 2119/04

(57) ABSTRACT

A digital twin system for predicting a residual life of a physical asset includes at least one user computer and at least one server. The user computer has a graphical user interface permitting a user to receive damage event warnings, end of life warnings, and status reports. The server communicates with the user computer and includes an administration subsystem that is in communication with a data source. The administration subsystem includes at least one database. The administration subsystem is configured to receive the physical asset's operating history data transmitted by the data source and store the operating history data into the database. The server further includes a simulator. The simulator is in communication with the administration subsystem and is configured to perform several functions, for example, updating the digital twin and generating residual life predictions.

### CROSS-REFERENCE TO RELATED APPLICATIONS

This application claims the benefit of U.S. Provisional Application No. 62/567,354, filed on Oct. 3, 2017. The entire disclosure of the above application is incorporated herein by reference.

### FIELD

The present disclosure relates to a method and system for fatigue analysis and, more particularly, a method and system for analyzing the fatigue life and damage state of a polymeric physical asset.

### BACKGROUND

Solutions for fatigue analysis from Finite Element Analysis (FEA) of components have been available for many years. Nonlimiting examples of fatigue analysis solutions for metallic components are described in each of:
Conle, F. A., and C-C. Chu. “Fatigue analysis and the local stress-strain approach in complex vehicular structures.” International Journal of Fatigue 19.93 (1997): 317-323;
Braschel, Reinhold, Manfred Miksch, and Rolf Schiffer. “Method of monitoring fatigue of structural component parts, for example, in nuclear power plants;”
U.S. Pat. No. 4,764,882 to Braschel et al., issued Aug. 16, 1988;
Yim, Hong Jae, and Sang Beom Lee. “An integrated CAE system for dynamic stress and fatigue life prediction of mechanical systems.” Journal of Mechanical Science and Technology 10.2 (1996): 158-168; and
Conle, F. A., and C. W. Mousseau. “Using vehicle dynamics simulations and finite-element results to generate fatigue life contours for chassis components.” International Journal of Fatigue 13.3 (1991): 195-205.

For many, FEA has become an essential part of maturing and qualifying design concepts. However, once these designs are finalized, it can be difficult to adequately track and predict the life cycle of a product due to actual loads and damage accrued, and when maintenance may be required. As used herein, the term “predict” is associated with the post-production context of a product, as opposed to being used in the pre-production context. Materials, mechanical parts, and structural supports generally require periodic inspection to ensure safety and function.

In traditional reactive maintenance methods, field engineers fix problems after faults are detected. Today's common practice is a “paper and pencil” based fixed schedule maintenance, which mainly relies on the experience of engineers responsible for the maintenance, and on visual inspection of the physical asset. These engineers often must review run time sensor data from the devices manually.

In theory, it is important to inspect the historical trending data to estimate the wear and tear of a specific machine. However, in practice, the historical data may show no problems exist before a catastrophe occurs, or the engineer may not be able to access the data on a vendor's server. Additionally, the physical asset is often not accessible for inspection, and damage may be difficult to detect on the physical asset. Thus, engineers are operating on limited information, resulting in inefficiencies and imprecision in maintenance.

There is a continuing need for a method and system for efficiently obtaining load histories at potential failure locations by incorporating FEA calculations into a simulation. Desirably, the system and method combine run time sensor data with the FEA-based system to more accurately predict when and where maintenance is required.

### SUMMARY

In concordance with the instant disclosure, a method and system for efficiently obtaining load histories at potential failure locations by incorporating FEA calculations into a digital twin simulation, and which combines run time sensor data with the FEA-based digital twin system to more accurately predict when maintenance is required, has been surprisingly discovered.

Assets tend to accumulate damage due to operating loads, exposure to the environment, and the like. Owners and operators often do not have accurate or complete information on remaining life, current state of damage, acceptable maintenance intervals, prior warning of failure. This leads to unexpected loss, failure, downtime, safety issues. Operating loads can be determined and recorded by an appropriate combination of sensors and computational modeling. The present disclosure includes a system for using at least one of actual and virtual load history to incrementally update a damage model of the asset.

Advantageously, and to create a more efficient process relative to the prior art, run time sensor data can be used according to the present method and system to create or update a “digital twin.” The term “digital twin” refers to a digital replica of physical assets, processes or systems that can be used to predict the life cycle and maintenance requirements of an item. The present system for using digital twins for predictive maintenance allows an engineer to know if an article requires maintenance before any wear or damage is noticed. The digital twin model may be implemented to execute any number of simulations, resulting in a model that accurately predicts degradation, end of life, and damage events.

The present method and system may periodically receive operational information from an asset, (e.g., recorded by load, displacement, temperature, acceleration sensors) and compute, for each period, the updated, current state of damage occurring in the asset. The system maintains current the damage state of a digital twin to reflect the effects of all operating history received from the sensors. The residual life may also be computed after each period, in terms of repeats of a hypothetical ideal load case, or in terms of repeats of the total history experienced previously. The system also may automatically generate status reports, maintenance reminders, diagnostics and warnings based upon computed estimates of remaining fatigue life. Importantly, fatigue calculations are also based on critical plane analysis.

In one embodiment, a digital twin system for predicting a residual life of a physical asset includes at least one user computer and at least one server. The at least one user computer has a graphical user interface permitting a user to receive at least one of a damage event warning, an end of life warning, and a status report. The at least one server in communication with the at least one user computer. The at least one server includes at least one processor and at least one memory. The at least one memory includes a tangible, non-transitory computer readable medium with processor-executable instructions stored thereon. The at least one server includes an administration subsystem in communication with a data source. The administration subsystem has at least one database and configured to receive operating history data of the physical asset from the data source and store the operating history data of the physical into the at least one database. The at least one server also includes a simulator in communication with the administration subsystem. The at least one server is configured for storing the digital twin of the physical asset. The digital twin includes a model of the physical asset and a current damage state. The at least one server is also configured for receiving a periodic residual life simulation request from the administration subsystem, receiving the operating history data of the physical asset from the administration subsystem, and updating the digital twin of the physical asset with the operating history data of the physical asset, using a fatigue solver algorithm to update the current damage state of the digital twin, thereby providing an updated digital twin. A residual life prediction for the physical asset is generated by using the fatigue solver algorithm with a hypothetical operating history data and the updated digital twin. The residual life prediction is indicative of the residual life before reaching a failure mode associated with the physical asset in operation.

The data source of the digital twin system may include at least one physical sensor in communication with the physical asset. The at least one sensor may be configured to monitor at least one of load, displacement, temperature, and acceleration of the physical asset. The physical asset may be formed from a polymeric or elastomeric material. The administration subsystem of the present disclosure may continuously and automatically receive the operational history data from the at least one sensor. The periodic residual life simulation requests themselves may occur at least one of once per minute, once per hour, and once per day. The data source may also be manual user input as the operating history data into the system via the at least one user computer.

The model may particularly be a finite element analysis model. The simulator may further comprise an interpolation engine. The fatigue solver algorithm may further include a critical plane analysis. For example, the fatigue solver algorithm may be defined by:

$$Δ {c}_{i \to i + 1 , j , k} = {{\int }^{{N}_{i + 1}}}_{{N}_{i}} r ( T ( {ε}_{mn} ( N ) , θ ( N ) , c ( N ) ) ) dN ,$$

wherein Δc is a change in crack length, i is a time period, j is an element of the model, k is a plane orientation, r is a crack growth rate, T is an energy release rate, εₘₙ is a strain tensor history, θ is a temperature history, c is a crack length, and N is cycles.

The hypothetical operating history data may also include cycles of a hypothetical ideal load case. The hypothetical operating history data may also be cycles of a total operating history of the physical asset.

In certain instances, the simulator automatically generates at least one of the damage event warning, the end of life warning, and the status report to the at least one user computer where a predetermined condition occurs. For example, the predetermined condition may include at least one of where the size of a crack exceeds a maximum size and where remaining cycles of an ideal hypothetical load case exceeds a minimum threshold. The user may further input the predetermined condition by manually inputting the predetermined condition into the system via the at least one user computer.

In additional instances, the data source may include a structural dynamics simulation. The structural dynamics simulation may use operational history of a second physical asset that is in communication with the physical asset to generate the operational history of the physical asset.

In another embodiment, a method for predicting a residual life of a physical asset includes the steps comprising providing the digital twin system and storing, by the simulator, the digital twin of the physical asset the at least one memory. The simulator receives the periodic residual life simulation from the administration subsystem. The simulator also receives the operating history data of the physical asset from the administration subsystem. The simulator further updates the digital twin of the physical asset with the operating history data of the physical asset, using a fatigue solver algorithm to update the current damage state of the digital twin, thereby providing an updated digital twin. The simulator then generates a residual life prediction for the physical asset by using the fatigue solver algorithm with a hypothetical operating history data and the updated digital twin. The residual life prediction is indicative of the residual life before reaching a failure mode associated with the physical asset in operation.

In an exemplary embodiment, a digital twin system for predicting a residual life of a physical asset includes at least one user computer and at least one server. The user computer has a graphical user interface permitting a user to receive damage event warnings, end of life warnings, and status reports.

The server communicates with the user computer and includes at least one memory. The memory includes a tangible, non-transitory computer readable medium with processor-executable instructions stored thereon. Additionally, the memory includes an administration subsystem that is in communication with a data source. The administration subsystem includes at least one database. The administration subsystem is configured to receive the physical asset's operating history data transmitted by the data source and store the operating history data into the database.

The memory further includes a simulator. The simulator is in communication with the administration subsystem and is configured to perform several functions, e.g. receiving periodic residual life simulation requests and operating history data of the physical asset from the administration subsystem. A further function of the simulator is storing the digital twin of the physical asset. This digital twin includes a model of the physical asset with the current damage state of the digital twin.

Another function of the simulator is to update the digital twin and generate residual life predictions. The simulator updates the digital twin by updating the current damage state of the digital twin using a fatigue solver algorithm and the operating history data of the physical asset. The simulator generates a residual life prediction for the physical asset by using the fatigue solver algorithm with a hypothetical operating history data and the updated digital twin.

In yet another embodiment, a method for predicting the residual life of a physical asset includes the first step of providing the digital twin system of the embodiment disclosed above. A second step of the simulator storing the digital twin of the physical asset. The digital twin includes the model of the physical asset with the current damage state of the physical asset. A third step of the simulator receiving the periodic residual life simulation request from the administration subsystem. A fourth step of the simulator receiving the operating history data of the physical asset from the administration subsystem.

A fifth step of the simulator updating the digital twin by updating the current damage state of the digital by using the fatigue solver algorithm with the operating history data of the physical asset. A sixth step of the simulator generating a residual life prediction for the physical asset by using the fatigue solver algorithm with a hypothetical operating history data and the updated digital twin. The residual life prediction is indicative of the residual life before reaching a failure mode associated with the physical asset in operation.

In a particular embodiment, the system disclosed above is modified to separate out the administration subsystem into its own administration server and the simulator into its own simulator server. The exemplary embodiment further includes at least one physical sensor as the data source. The physical sensor is in communication with the physical asset and is configured to monitor the load, displacement, temperature, and acceleration of the physical asset. Additionally, a user could act as the data source by manually inputting the operating history data into the system using the user computer.

The hypothetical operating history data is cycles of a hypothetical ideal load case or cycles of a total operation history of the physical asset. Also, the simulator server is further configured to generate the damage event warnings, end of life warnings, and status reports to the user computer where the size of a crack exceeds a maximum size or where remaining cycles of ideal hypothetical load case exceeds a minimum threshold. Additionally, the simulator server further comprises a critical plane analysis with the fatigue solver algorithm. The fatigue solver algorithm used by the simulator server is:

$$Δ {c}_{i \to i + 1 , j , k} = {{\int }^{{N}_{i + 1}}}_{{N}_{i}} r ( T ( {ε}_{mn} ( N ) , θ ( N ) , c ( N ) ) ) dN$$

The equation has the following variables: Δc is the change in crack length, i is the period, j is the element of the model, k is the plane orientation, r is the crack growth rate, Tis the energy release rate, εₘₙ is the strain tensor history, θ is the temperature history, c is crack length, and N is the cycles.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is a flow chart illustrating a digital twin system for predicting a residual life of a physical asset, according to one embodiment of the disclosure;

FIG. 2 is a flow chart illustrating a method for updating a damage state of a digital twin generated according to the digital twin system of FIG. 1;

FIG. 3 is an exemplary fatigue solver algorithm for use with the digital twin system of FIG. 1;

FIG. 4 is a table depicting of an exemplary restart file for use with the digital twin system of FIG. 1;

FIG. 5 is a flow chart illustrating a method for updating the damage state of the digital twin for multiple time periods;

FIG. 6 is a graphic illustrating an exemplary finite element model for a first time period, and in particular a finite element model with a damage field caused by 10,000 repeats of a single load case, and where crack length is updated and stored for each element;

FIG. 7 is a graphic illustrating the finite element model of FIG. 6 updated for a second time period, and in particular a finite element model with a damage field updated from a second load case, and where crack length is updated and stored for each element;

FIG. 8 is a flow chart illustrating a method for generating a residual life prediction for multiple time periods;

FIG. 9 is a table depicting an exemplary real-world application of the digital twin system;

FIG. 10 is a flow chart illustrating a method for updating the damage state of the digital twin with an interpolation engine, according to one embodiment of the disclosure; and

FIG. 11 is a flow chart illustrating a method for updating the damage state of the digital twin with a structural dynamics simulation.

### DETAILED DESCRIPTION

The following detailed description and appended drawings describe and illustrate various embodiments of the invention. The description and drawings serve to enable one skilled in the art to make and use the invention and are not intended to limit the scope of the invention in any manner. In respect of the methods disclosed, the order of the steps presented is exemplary in nature, and thus, is not necessary or critical unless otherwise disclosed.

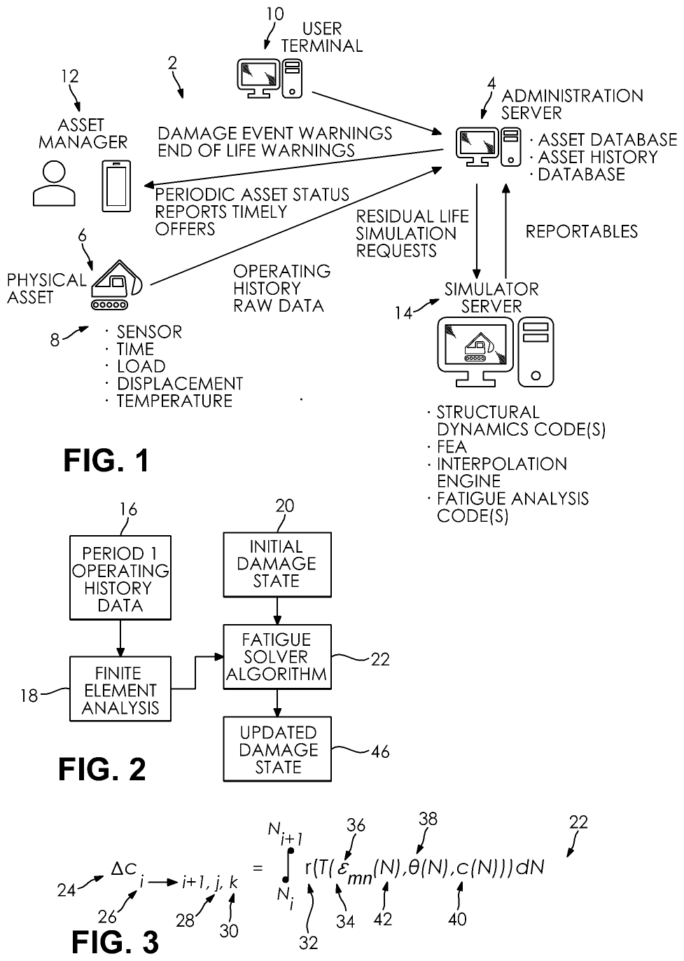

A digital twin system 2 for predicting a residual life of a physical asset 6 is shown in FIG. 1. The digital twin system 2 includes an administration server 4 having a graphical user interface, the physical asset 6, at least one sensor 8, a user terminal 10 having a graphical user interface, an asset manager 12 having a graphical user interface, and a simulator server 14 having a graphical user interface. The administration server 4 and the simulator server 14 can be different subsystems of a single server or can be multiple administration servers 4 and multiple simulator servers 14. It should be appreciated that the number of servers can be scalable, and a skilled artisan may employ any suitable number of servers within the scope of the disclosure.

It should be appreciated that the at least one server has sufficient processing power and memory in order to store and process the run time data, FEA, and digital twin models as described herein in a timely manner. For example, on a simulator server 14 with 24G of RAM and six (6) processing cores, processing thirty (30) minutes of operating history data sampled at 500 Hz (roughly 1 million time steps) for 50,000 elements used 6 MB of RAM per finite element for the fatigue analysis. Although these minimum hardware requirements have been found especially useful for timely processing according to the present method, other suitable hardware requirements for processing the method of the present disclosure may also be selected by the skilled artisan, as desired.

The administration server 4 is in communication with the at least one sensor 8, the asset manager 12, the user terminal 10, and the simulator server 14. The administration server 4 includes a tangible, non-transitory computer readable medium with processor-executable instructions stored thereon. The memory includes at least one database. One function of the administration server 4 is acting as a database that stores an initial damage state of the physical asset 6 and an operating history data of the physical asset 6.

It should be understood that the physical asset 6 of the present disclosure is any asset comprising, consisting of, or consisting essentially of polymeric or elastomeric materials. As non-limiting examples, this may include bushings, seals, or tires. Other types of polymeric or elastomeric products may also be employed as the physical asset 6, as desired.

As used herein, the refers to “initial damage state” a predetermined state associated with each finite element of a model of the physical asset 6. The initial damage state may be provided in the form of a user-defined file that contains material definitions, output requests and strain history associated with the physical asset 6. The operating history data may include variables that are measurements of time, load, displacement, and temperature over a specific or predetermined time period. One skilled in the art may include more variables to monitor additional aspects of the physical asset 6.

Another function of the administration server 4 is to automatically transmit status reports, maintenance reminders, diagnostics and warnings to the asset manager 12 based upon the residual life predictions generated by the simulator server 14 where the predictions exceed a predetermined boundary. For example, where the size of a crack exceeds a maximum size and where remaining cycles of an ideal hypothetical load case exceeds a minimum threshold, the administration server 4 may be configured to automatically transmit a warning signal.

The at least one sensor 8 is in communication with the physical asset 6 and the administration server 4. The at least one sensor 8 monitors the physical asset 6 and collects the operating history data. For example, the at least one sensor 8 may include a physical sensor disposed on or adjacent to or in communication with the physical asset 6, or otherwise configured to monitor, at least one of time, load, displacement, and temperature of the physical asset 6 in operation. This data collection by the at least one sensor 8 may be performed automatically and may be continuously or intermittently transmitted to the administration server 4 to permit the processes for updating the digital twin to occur. Optionally, the operational history data can be manually inputted into the digital twin system 2 by a user via the user terminal 10. This is useful when a sensor 8 malfunctions or a sensor 8 isn't available to measure a specific variable.

The simulator server 14 is in communication with the administration server 4 and includes a tangible, non-transitory computer readable medium with processor-executable instructions stored thereon. One function of the simulator server 14 is periodically receive residual simulation requests and the operating history data from the administration server 4. The administration server 4 may periodically generate these requests, for example, once per minute, once per hour, once per day, or any other periodicity selected by a skilled artisan. Further functions of the simulation server 14 may include, as non-limiting examples: storing the digital twin of the physical asset 6; creating or updating the digital twin to synchronize its damage state with the physical asset 6; and generating residual life predictions for the physical asset 6.

In operation, as shown in FIG. 2, the simulator server 14 may perform a residual life prediction process upon receiving a request from the administration server 4. This residual life prediction process starts by the simulator server 14 receiving a set of “period 1” operating history data from the administration server 4. Next, the simulator server 14 incorporates the “period 1” operating history data 16 into a finite element model using a step of finite element analysis or FEA 18.

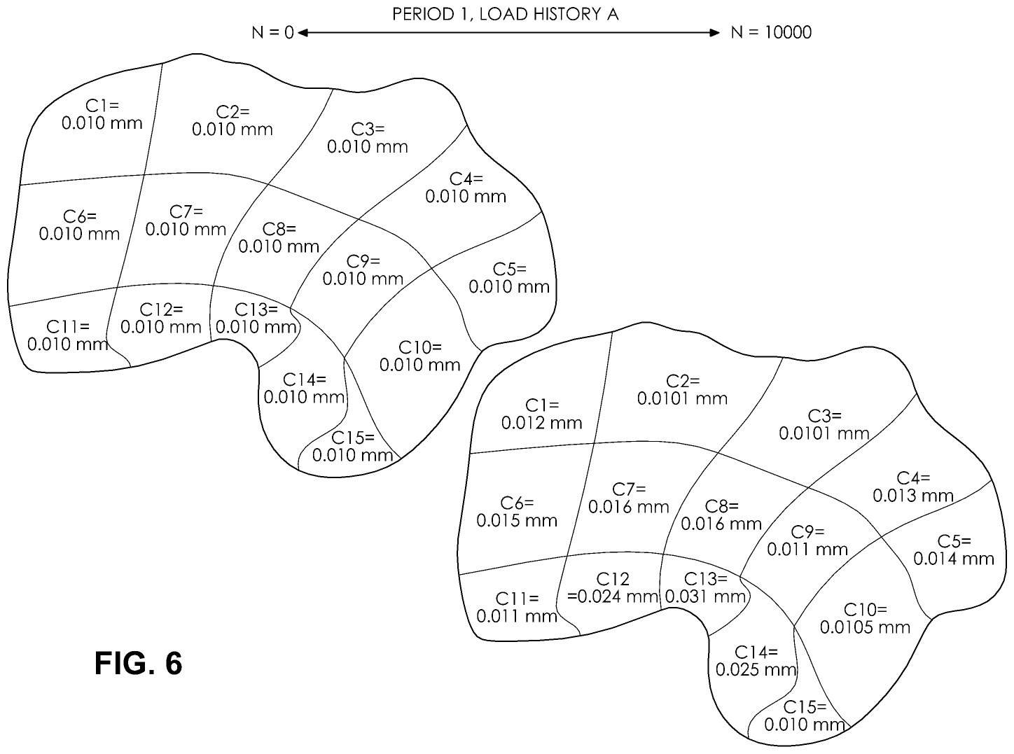

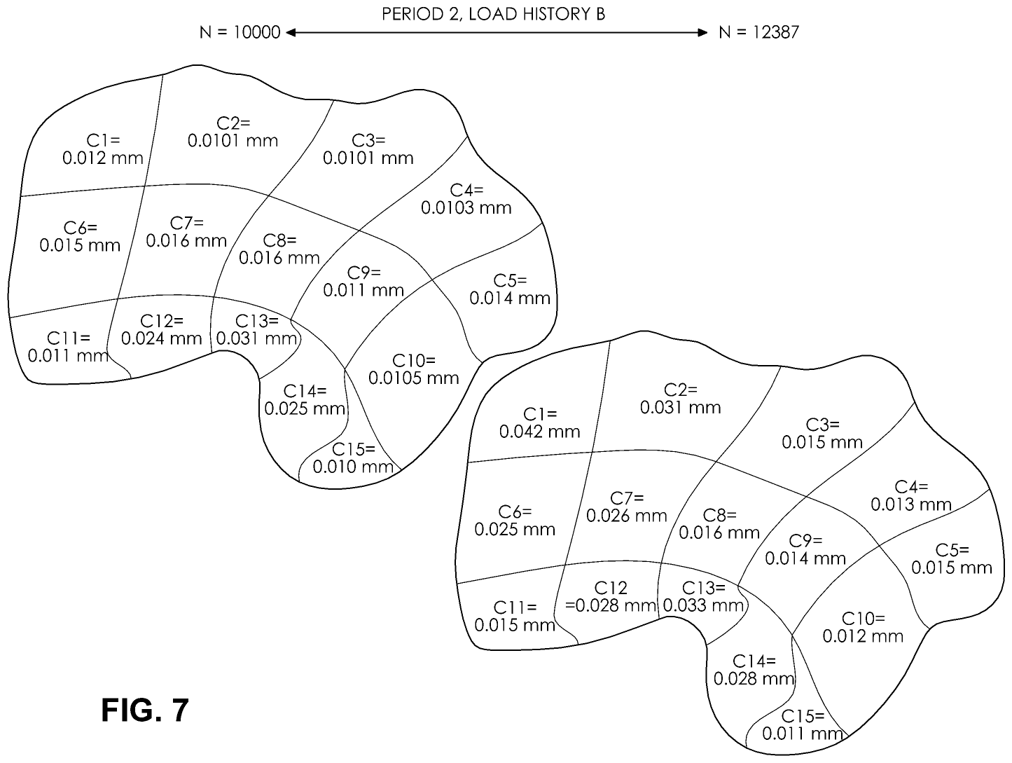

The finite element models of the present disclosure include a set of individual finite elements, each of which contains information about stresses and strains, and also the size of cracks in each element, for example, as shown in FIGS. 6-7. The information about stresses and strains may be read programmatically from files written by finite element code associated with the FEA 18. The information about crack size may be read programmatically from files written by the fatigue solver algorithm 22.

One suitable method and system for creating a finite element model was described in U.S. Pat. Appl. Publication No. 2004/0254772 to Su, the entire disclosure of which is hereby incorporated herein by reference. Other suitable methods for acquiring and processing load data or other time-varying load data may also be used within the scope of the present disclosure.

With renewed reference to FIG. 2, then, the simulator server 14 incorporates the physical asset's initial damage state 20 into the finite element model by using a fatigue solver algorithm 22. As disclosed hereinabove, the initial damage state 20 is a user-defined file that contains the material definitions, output requests and strain history, as non-limiting examples. In the initial damage state 20, each of the elements of the finite element model may have a predefined or default initial crack length associated therewith, for example, as shown in FIG. 6 at N=0.

In preferred embodiments, the fatigue solver algorithm 22 is based upon the principles of critical plane analysis. Critical plane analysis refers to the analysis of stresses or strains as they are experienced by a particular plane in a material, as well as the identification of which plane is likely to experience the most extreme damage. Critical plane analysis may be used in engineering to account for the effects of cyclic, multiaxial load histories on the fatigue life of materials and structures. Different critical plane analyses are described in the following references, the entire disclosures of which are also hereby incorporated herein by reference.
Fatemi, Ali, and Darrell F. Socie. “A Critical Plane Approach to Multiaxial Fatigue Damage Including out-of-Phase Loading.” Fatigue & Fracture of Engineering Materials & Structures 11, no. 3 (1988): 149-165.
Barbash, Kevin P., and William V. Mars. Critical Plane Analysis of Rubber Bushing Durability under Road Loads. No. 2016-01-0393. SAE Technical Paper, 2016.
Mars, W. V. “Fatigue life prediction for elastomeric structures.” Rubber chemistry and technology 80, no. 3 (2007): 481-503.
Mars, William Vernon. “Method and article of manufacture for estimating material failure due to crack formation and growth.” U.S. Pat. No. 6,634,236, issued Oct. 21, 2003.
Papadopoulos, loannis V. “Critical plane approaches in high-cycle fatigue: on the definition of the amplitude and mean value of the shear stress acting on the critical plane.” Fatigue & Fracture of Engineering Materials & Structures 21, no. 3 (1998): 269-285.
Goossens, Joshua R., William Mars, Guy Smith, Paul Heil, Scott Braddock, and Jeanette Pilarski. Durability Analysis of 3-Axis Input to Elastomeric Front Lower Control Arm Vertical Ride Bushing. No. 2017-01-1857. SAE Technical Paper, 2017.

FIG. 3. illustrates the fatigue solver algorithm 22 used in one embodiment of the digital twin system, and is also replicated below.

$$Δ {c}_{i \to i + 1 , j , k} = {{\int }^{{N}_{i + 1}}}_{{N}_{i}} r ( T ( {ε}_{mn} ( N ) , θ ( N ) , c ( N ) ) ) dN$$

The fatigue solver algorithm 22 has the following variables:
Δc is the change in crack length 24;
i is the period 26;
j is the element of the model 28;
k is the plane orientation 30;
r is the crack growth rate 32;
T is the energy release rate 34;
εₘₙ is the strain tensor history 36;
θ is the temperature history 38;
c is crack length 40; and
N is the cycles 42.

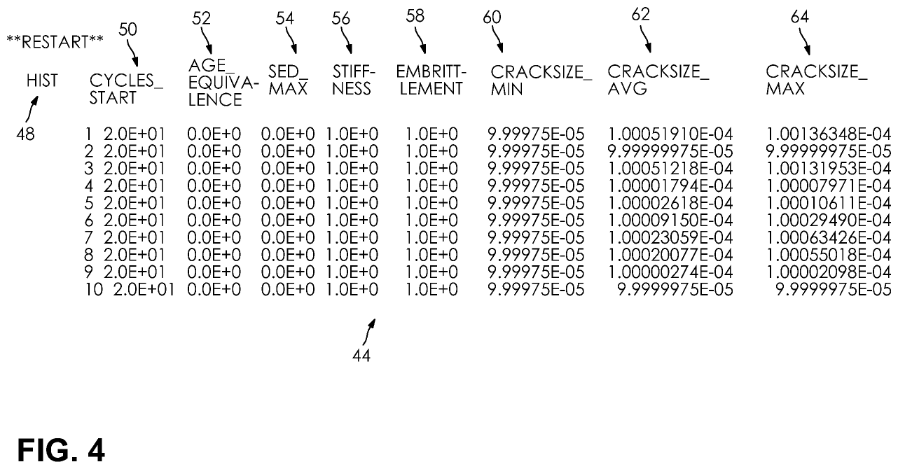

The simulator server 14 writes the result of the fatigue solver algorithm 22 to a file called a “restart file,” identified by reference number “44” in FIG. 4. The restart file 44 represents an updated damage state 46 of the physical asset 6. Where the updated damage state 46 and the physical asset 6 have a same operating state and history at a current moment in time, the updated damage state 46 may be considered representative of the “digital twin” of the physical asset 6.

FIG. 4 illustrates the restart file 44 according to one embodiment of the present disclosure. The first column, HIST 48, is an index of the current element number of the finite element model. The second column, CYCLES_START 50, is a number of cycles accumulated during the past history. The third column, AGE_EQUIVALANCE 52, is an equivalent heat-aging time accumulated at the reference temperature. The fourth column, SED_MAX 54, is a prior all time maximum of strain energy density in the element.

The fifth column, STIFFNESS 56, is a multiplier of an original stiffness to account for cyclic softening in operation. The sixth column, EMBRITTLEMENT 58, is a multiplier of the original stiffness to account for aging over the operational history. The seventh column, CRACKSIZE_MIN 60, is a smallest crack size associated with the critical plane obtained during the prior analysis (i.e., the immediately prior restart file 44). The eighth column, CRACKSIZE_AVG 62, is the average crack size from the critical plane search of the prior analysis. The ninth column, CRACKSIZE_MAX 64, is the largest crack size from the critical plane search of the prior analysis.

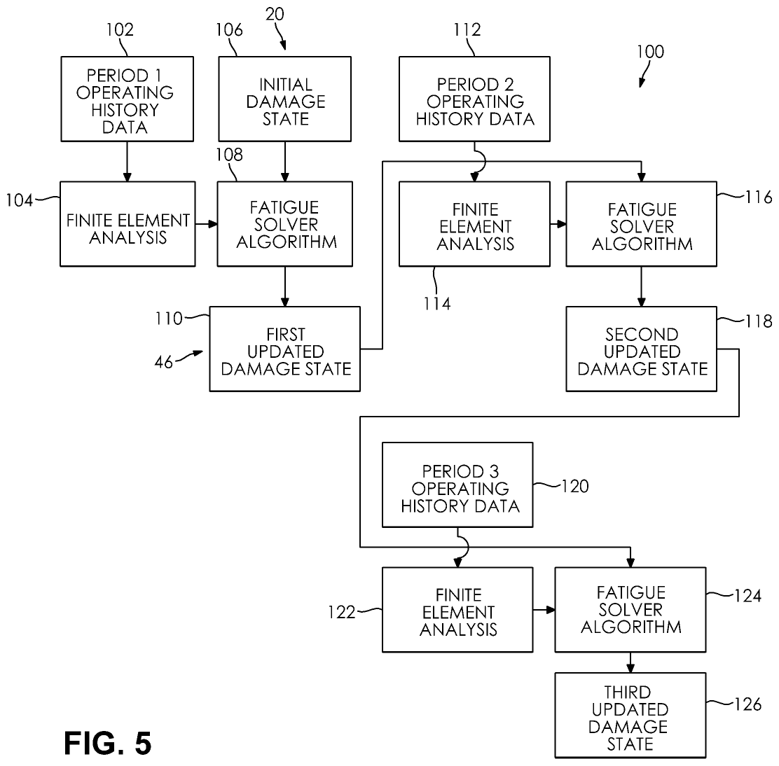

Referring now to FIG. 5, a flow chart illustrates a method 100 for updating the damage state of the digital twin for multiple time periods. The method includes a step 102 of providing “Period 1” operating history data for a finite element analysis step 104. In a step 106, the initial damage state 20 is also provided. Each of the initial damage state 20 and the results of the finite element analysis step 104 are employed in the fatigue solver algorithm 22 in a step 108. The output of the fatigue solver algorithm 22 in the form of a first updated damage state 46 is provided in a step 110. Subsequently, in a step 112, “Period 2” operating history data is provided for a finite element analysis step 114. The fatigue updated damage state 46 and the results of the finite element analysis step 114 are employed in the fatigue solver algorithm 22 in a step 116. The output of the fatigue solver algorithm 22 in the form of a second updated damage state 46 is provided in a step 118. This general process may be further repeated, for each subsequent period, for example, in a step 120 of providing “Period 3” operating history data for a finite element analysis step 122, which in turn is supplied to the fatigue solver algorithm for a step 124, resulting in a third update damage state 46 in a step 126.

As shown in FIGS. 6-7, the updated damage state 46 allows the simulator server 14 to update the digital twin during subsequent residual simulation requests. The process is similar to creating the original digital twin except the initial damage state 20 is substituted by the updated damage state 46. Using this method, there is no requirement that the duty cycle during one period be the same as the duty cycle in subsequent periods. The crack length (C1-C15) associated with each of the finite elements is updated in as many periods as needed, for example, according to the method shown in FIG. 5, to virtually represent the operation of the physical asset 6 in the real world.

It should be appreciated that the incremental procedure described hereinabove readily accounts for effects associated with the order in which events occur with respect to the physical asset 6 in operation. For example, a series of severe loads occurring early in service of the physical asset 6 may induce greater (or lesser) damage than the same loads applied later in life, depending on, for example, the Mullins effect and mode of control details, among other variables.

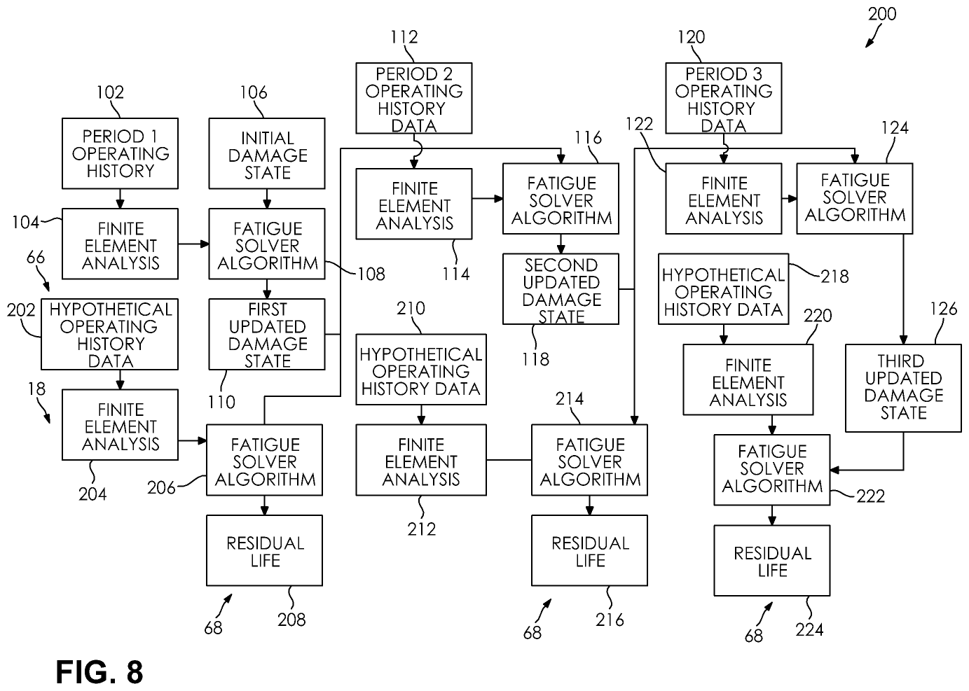

After the simulator server 14 creates or updates the digital twin as shown in FIGS. 5-7, the simulator server 14 can generate a residual life prediction in a method 200 as shown in FIG. 8. The process starts by the simulator server 14 receiving a hypothetical operating history data 66 in a step 202. This hypothetical operating history data 66 can be cycles of a hypothetical ideal load case or cycles of the total operation history of the physical asset 6, for example. It should be appreciated that the hypothetical operating history data 66 can also be data manually input by the asset manager 12 using the user computer 10.

Next, in a step 204, the simulator server 14 incorporates the hypothetical operating history data 66 into a model such as a finite element model using FEA 18. Then, in a step 206, the simulator server 14 incorporates the updated damage state 46 of the physical asset 6 and the finite element model parameters into the fatigue solver algorithm 22. A hypothetical updated damage state is then output from the fatigue solver algorithm 22 in a step 208, which is then used to repeat the same process until the hypothetical updated damage state is within the boundaries of a predefined or predetermined failure mode for the physical asset 6. Likewise, the hypothetical operating history data may be supplied and used in each of steps 210-224 shown in FIG. 8 until the hypothetical updated damage state is within the boundaries of the predefined or predetermined failure mode for the physical asset 6. The amount of cycles it takes to reach this failure mode is the residual life prediction 68 of the physical asset 6.

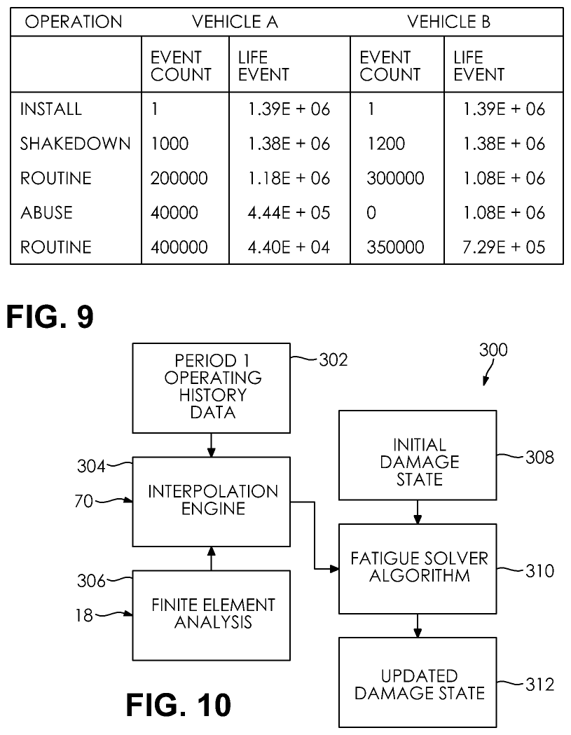

A practical application of the residual life prediction 68 methodology is shown in FIG. 9. In this example, vehicle “A” and “B” are initially identical but have different usage. Four different usage types are considered, namely: installation, shakedown, routine use, and abuse. Each of these four types have a particular loading history. The “Event Count” column in FIG. 9 shows the number of repeats of the routine use type that are computed as causing part failure.

For example, vehicle “A” could hypothetically endure 1.39E6 repeats of the routine case immediately following the installation load history, and that number of repeats is reduced following the application of each new operation in the history. The abuse events applied to vehicle “A” are seen to produce an especially large drop in life left. Vehicle A at the end of all operations only has 4.40E4 repeats of the routine case remain. Although vehicle “B” has undergone a large number of routine events, it has a larger remaining life at the end of the schedule because it did not experience the abuse case.

In another embodiment, the digital twin system can further comprise an interpolation engine 70 as shown in FIG. 10 and described in Applicant's co-owned U.S. Pat. No. 9,645,041 to Mars, the entire disclosure of which is hereby incorporated herein by reference. Advantageously, the interpolation engine 70 allows the digital twin system to rapidly process long time histories. This is accomplished by using the interpolation engine 70 in conjunction with the FEA 18. The interpolation engine 70 allows the FEA 18 to partially generate parameters some of the finite elements, while the interpolation engine 70 interpolates parameters for the rest of the finite elements in the digital twin.

In particular, FIG. 10 shows a method 300 which includes a step 302 of providing the “Period 1” operating history data for use in the interpolation engine according to step 304. Parameters from the finite element analysis 18 from a step 306 are also used with the parameters from the interpolation step 304 in the fatigue solver algorithm in a step 310. The fatigue solver algorithm also employs the initial damage state provided in a step 308. An updated damage state obtained through use of the interpolation engine 70 is thereby provided as an output of the fatigue solver algorithm in a step 312.

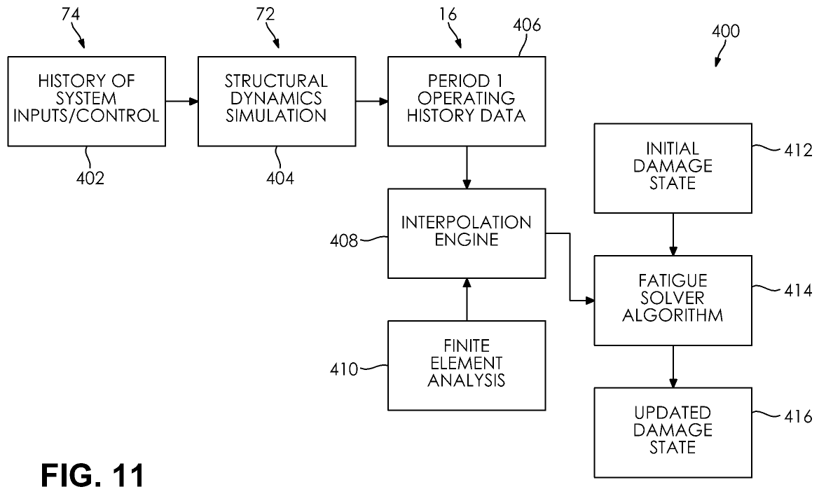

In a further embodiment, the digital twin system can further comprise a method 400 involving a structural dynamics simulation 72, for example, as shown in FIG. 11. The structural dynamics simulation may use operational history of a second physical asset that is in communication with the physical asset 6 to generate the operational history of the physical asset 6, for example. The method 400 includes a step 402 or providing a history of system inputs as a control. The structural dynamics simulation 72 allows the digital twin system to use this history of the system inputs to determine the “Period 1” operating history data 16. This is accomplished by incorporating the history of the system inputs into the structural dynamics simulation 72 to generate the “Period 1” operating history data 16 of the physical asset 6. This advantageously allows the digital twin system to calculate residual life predictions 68 for physical assets 6 not directly monitored but that are within the same system, for example, according to steps 406-416.

It should be understood that the system 2 and methods 100, 200, 300, 400 of the present disclosure efficiently obtain load histories at potential failure locations of physical assets and incorporate FEA calculations into digital twin simulations. The system 2 and methods 100, 200, 300, 400 may further combine run time sensor data with the FEA-based digital twin system, as detailed hereinabove, to more accurately predict when maintenance is required for physical assets 6 having the digital twins.

While certain representative embodiments and details have been shown for purposes of illustrating the invention, it will be apparent to those skilled in the art that various changes may be made without departing from the scope of the disclosure, which is further described in the following appended claims.

What is claimed is:

1. A method for predicting a residual life of a physical asset including a polymeric or elastomeric material, comprising:
providing the physical asset including the polymeric or elastomeric material;
providing a digital twin system including a sensor, an administration server, a user terminal, an asset manager, and a simulator server, wherein:
the sensor is in communication with the physical asset and the administration server, the sensor configured to monitor the physical asset in operation and collect periodic operating history data;
the administration server includes a graphical user interface, a processor, and a memory, the administration server is in communication with the sensor, the user terminal, the asset manager, and the simulator server, the administration server includes a tangible, non-transitory computer readable medium with processor-executable instructions stored thereon, the memory includes a database that stores an initial damage state of the physical asset and the periodic operating history data of the physical asset, the administration server configured to transmit an end of life warning of the physical asset to the asset manager;
the user terminal includes a graphical user interface;
the asset manager includes a graphical user interface;
the simulator server includes a graphical user interface and a tangible, non-transitory computer readable medium with processor-executable instructions stored thereon, the simulator server configured to periodically receive residual simulation requests and the operating history data from the administration server, the simulation server storing a digital twin of the physical asset and configured to update the digital twin to synchronize a damage state with the physical asset and generate a residual life prediction for the physical asset;
using the sensor to monitor the physical asset in operation and collect the periodic operating history data;
using the simulator server to perform a residual life prediction process, wherein the simulator server receives the periodic operating history data from the administration server and incorporates the periodic operating history data into a finite element model using a step of finite element analysis, the simulator server incorporating the initial damage state of the physical asset into the finite element model by using a fatigue solver algorithm, the fatigue solver algorithm based upon critical plane analysis, wherein the digital twin is updated to synchronize the damage state with the physical asset and generate the residual life prediction for the physical asset;
using the simulator server to receive a hypothetical operating history data;
repeatedly using the simulator server to incorporate the hypothetical operating history data into the finite element model and incorporate an updated hypothetical damage state of the physical asset and the finite element model into the fatigue solver algorithm until the updated hypothetical updated damage state is within a boundary of a predetermined failure mode for the physical asset, wherein an amount of repeated cycles it takes to reach the predetermined failure mode is the residual life prediction of the physical asset;
transmitting the end of life warning of the physical asset to the asset manager based upon the residual life prediction of the physical asset; and
replacing the physical asset with another physical asset based upon the end of life warning.

2. The method of claim 1, wherein the sensor is configured to monitor a characteristic of the physical asset, the periodic operating history data including the characteristic.

3. The method of claim 2, wherein the characteristic includes a member selected from a group consisting of a load of the physical asset, a displacement of the physical asset, a temperature of the physical asset, an acceleration of the physical asset, and combinations thereof.

4. The method of claim 1, wherein the sensor is configured to continuously monitor the physical asset.

5. The method of claim 1, wherein the sensor is configured to intermittently monitor the the physical asset based on a predefined schedule.

6. The method of claim 1, wherein the administration server is configured to communicate with the sensor following a request for the periodic operating history data from the administration server.

7. The method of claim 1, wherein the administration server and the sensor are configured to communicate the periodic operating history data in response to detection of a threshold event.

8. The method of claim 1, wherein the fatigue solver algorithm comprises:
$$Δ {c}_{i \to i + 1 , j , k} = {{\int }^{{N}_{i + 1}}}_{{N}_{i}} r ( T ( {ε}_{mn} ( N ) , θ ( N ) , c ( N ) ) ) dN$$
wherein,
Δc is a change in crack length,
i is a time period,
j is an element of the model,
k is a plane orientation,
r is a crack growth rate,
T is an energy release rate,
εₘₙ is a strain tensor history,
θ is a temperature history,
c is a crack length, and
N is cycles.

9. The method of claim 1, wherein the physical asset is entirely formed from the polymeric or elastomeric material.

10. The method of claim 9, wherein the physical asset includes a member selected from a group consisting of a bushing, a seal, and a tire.

11. The method of claim 1, wherein the graphical user interface of the user terminal permits the asset manager to input operational parameters that influence a processing of the periodic operating history data by the fatigue solver algorithm.

12. The method of claim 1, wherein the administration server is further configured to automatically generate and transmit a maintenance reminder to the asset manager based on the residual life prediction.

13. The method of claim 1, wherein the digital twin system is configured to receive and incorporate structural dynamics simulation data from a second physical asset in communication with the physical asset to enhance an accuracy of the residual life prediction.

14. A system for predicting a residual life of a physical asset including a polymeric or elastomeric material, comprising:
the physical asset including the polymeric or elastomeric material;
a digital twin system including a sensor, an administration server, a user terminal, an asset manager, and a simulator server, wherein:
the sensor is in communication with the physical asset and the administration server, the sensor configured to monitor the physical asset in operation and collect periodic operating history data;
the administration server includes a graphical user interface, a processor, and a memory, the administration server is in communication with the sensor, the user terminal, the asset manager, and the simulator server, the administration server includes a tangible, non-transitory computer readable medium with processor-executable instructions stored thereon, the memory includes a database that stores an initial damage state of the physical asset and the periodic operating history data of the physical asset, the administration server configured to transmit an end of life warning of the physical asset to the asset manager;
the user terminal includes a graphical user interface;
the asset manager includes a graphical user interface;
the simulator server includes a graphical user interface and a tangible, non-transitory computer readable medium with processor-executable instructions stored thereon, the simulator server configured to periodically receive residual simulation requests and the operating history data from the administration server, the simulation server storing a digital twin of the physical asset and configured to update the digital twin to synchronize a damage state with the physical asset and generate a residual life prediction for the physical asset;
wherein the sensor is configured to monitor the physical asset in operation and collect the periodic operating history data;
wherein the simulator server is configured to perform a residual life prediction process, wherein the simulator server receives the periodic operating history data from the administration server and incorporates the periodic operating history data into a finite element model using a step of finite element analysis, the simulator server incorporating the initial damage state of the physical asset into the finite element model by using a fatigue solver algorithm, the fatigue solver algorithm based upon critical plane analysis, wherein the digital twin is updated to synchronize the damage state with the physical asset and generate the residual life prediction for the physical asset;
wherein the simulator server is configured to receive a hypothetical operating history data;
wherein the simulator server is configured to repeatedly incorporate the hypothetical operating history data into the finite element model and incorporate an updated hypothetical damage state of the physical asset and the finite element model into the fatigue solver algorithm until the updated hypothetical updated damage state is within a boundary of a predetermined failure mode for the physical asset, wherein an amount of repeated cycles it takes to reach the predetermined failure mode is the residual life prediction of the physical asset;
wherein the end of life warning is transmitted to the physical asset to the asset manager based upon the residual life prediction of the physical asset; and
wherein the physical asset is replaced with another physical asset based upon the end of life warning.

15. The system of claim 14, wherein the sensor is configured to monitor a characteristic of the physical asset, the periodic operating history data including the characteristic.

16. The system of claim 15, wherein the characteristic includes a member selected from a group consisting of a load of the physical asset, a displacement of the physical asset, a temperature of the physical asset, an acceleration of the physical asset, and combinations thereof.

17. The system of claim 14, wherein the physical asset is entirely formed from the polymeric or elastomeric material.

18. The system of claim 17, wherein the physical asset includes a member selected from a group consisting of a bushing, a seal, and a tire.

19. The system of claim 14, wherein the fatigue solver algorithm comprises:
$$Δ {c}_{i \to i + 1 , j , k} = {{\int }^{{N}_{i + 1}}}_{{N}_{i}} r ( T ( {ε}_{mn} ( N ) , θ ( N ) , c ( N ) ) ) dN ,$$
wherein
Δc is a change in crack length,
i is a time period,
j is an element of the model,
k is a plane orientation,
r is a crack growth rate,
T is an energy release rate,
εₘₙ is a strain tensor history,
θ is a temperature history,
c is a crack length, and
N is cycles.
